(19) United States
(12) Patent Application Publication
(10) Pub. No.: US 2007/0211671 A1
(43) Pub. Date: Sep. 13, 2007

(54) METHOD AND APPARATUS FOR A FLEXIBLE PREAMBLE AND EFFICIENT TRANSMISSION THEREOF

(75) Inventor: Inhyok Cha, Yardley, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/684,177

(22) Filed: Mar. 9, 2007

Related U.S. Application Data
(60) Provisional application No. 60/780,581, filed on Mar. 9, 2006.

(51) Int. Cl. H04B 7/216

(52) U.S. Cl. 370/335

(57) ABSTRACT

A method and apparatus for a flexible physical random access channel (PRACH) preamble are disclosed. A wireless transmit/receive unit (WTRU) transmits a PRACH preamble generated by using a scrambling code and a signature code to a Node B to access the channel. The WTRU incorporates PRACH access information and preamble channel resources into the preamble, thereby providing flexibility and efficiency in transmission of the PRACH preamble. The method and apparatus may also be applied to an acquisition indicator channel preamble, a high speed uplink packet access channel preamble, an orthogonal frequency division multiplexing preamble, or an orthogonal frequency division multiple access preamble.

### CROSS REFERENCE TO RELATED APPLICATION

This application claims the benefit of U.S. Provisional Application No. 60/780,581, filed Mar. 9, 2006, which is incorporated by reference as if fully set forth herein.

### FIELD OF INVENTION

The present invention relates to wireless communication systems, and more particularly, to a method and apparatus for a flexible physical random access channel (PRACH) preamble.

### BACKGROUND

In accordance with a current third generation partnership project (3GPP), a PRACH preamble is used for uplink random access. A user equipment (UE) requests an access grant (e.g., registering with the network or initiating a call) from a Node B using short and simple messages. The current PRACH preamble carries four bits of access information (AI), which are implicitly indicated by the choice of a signature (out of a possible 16 signatures) embedded in the PRACH preamble.

The four bit signature AI is carried in a “wrapper format” comprising a 4096 chip scrambling code modulated by a 256 times repetition (i.e., a spreading factor of 256) of a 16 chip long signature. The current PRACH preamble is given by:

$${C}_{pre , n , s} ( k ) = {S}_{r \text{-} pre , n} ( k ) \times {C}_{sig , s} ( k ) = {ⅇ}^{j ( \frac{π}{2} + \frac{π}{2} k )} , \\ k = 0 , 1 , … , 4095 \qquad Equation ( 1 )$$

where S_{r-pre,n}(i)=c_{long,1,n}(i), i=0, 1, . . . , 4095, i.e., a 4096 chip long section of a long scrambling code, and C_{sig,s}(i)=Pₛ(i modulo 16), i=0, 1, . . . , 4095, with Pₛ(n) given by one of 16 Hadamard sequences of length 16.

FIG. 1 is a block diagram of a receiver 100 including a detector for an existing RACH preamble. At the receiver 100, a preamble signal 102 is received by a preamble detector 104. The preamble detector 104 outputs three signals: (1) a detection indication (a yes or no value), (2) a signature index, and (3) a detected timing offset. The detection indication and the signature index are provided to an access indicator channel (AICH) transmitter 106 which outputs an AICH signal 108. A RACH message signal 110 is received by a RACH message receiver 112, which uses the detected timing offset from the preamble detector 104 to properly receive the message signal 110.

The processing gain of the user information (four bits for the signature) is 1024, or equivalently, 30 dB. There are 16 orthogonal signatures and 15 non-overlapping access slots per 20 ms. The availability of the orthogonal access slots and signatures and the high processing gain together ensure a high probability of a successful access attempt by even the worst-case (e.g., cell-edge) users.

However, the current design may be limiting the system performance due to its simplicity and ensured success. The high processing gain could be excessive and wasteful in certain cases. Although open-loop link-loss estimation is intended to be used to set up the initial preamble transmit power levels and to mitigate uplink interference, it still does not address the inherent inflexibility in the fixed processing gain design. In some UEs that are close to the Node B, if their transmitter does not have the capability to set the transmit power to sufficiently low levels, there will not only be a waste of power for the UE but also an unnecessary boost in uplink interference for the cell.

In the prior art, there is no flexibility in choosing the processing gain. For example, the same PRACH preamble with the same processing gain has to be used for all users, regardless of whether the users have different requirements or are located in different situations. For example, the users may be different distances from the cell or have different requirements on the access (e.g., priority, response speed, etc).

There may be design imbalances in the current PRACH design versus the RACH message part design. In any one 10 ms interval, theoretically as many as 120 non-overlapping access attempts can be made (16 signatures×7.5 access slots/10 ms=120 possible accesses). However, even if all 120 preambles are successfully detected, most channel cards at the Node B will not have the processing power to process all the impending RACH message signals that would be transmitted after a success indication carried on the AICHs. Also, the preamble can only carry the four bit AI, which is the signature choice, and nothing else. Although the preamble is the first signal received by the Node B in the access strata, other information (such as desired access priority, user situation, etc.) is not carried in the PRACH preamble itself.

Therefore, there is a need in the art to include additional information in the PRACH preamble.

### SUMMARY

In accordance with the present invention, PRACH access information (PAI) and/or preamble channel resources (PCR) are carried by the PRACH preamble. The PAI includes information about the user or the access that the user desires, and the PCR indicates channel resources for the PRACH preamble.

The benefits of the present invention include: simplifying the decoder processing, maximizing re-use of receiver function blocks for a legacy preamble (such as the FHT block), and providing flexibility in the size and type of the PAI information to be carried.

### BRIEF DESCRIPTION OF THE DRAWINGS

A more detailed understanding of the invention may be had from the following description of a preferred embodiment, given by way of example and to be understood in conjunction with the accompanying drawings, wherein:

FIG. 1 is a block diagram of a receiver including a detector for an existing RACH preamble;

FIG. 2 is a diagram of a preamble that adds the PAI bits to an existing signature;

FIG. 3 shows a timing relationship between multiple preambles and a corresponding acquisition indicator;

FIG. 4 is a diagram of a preamble including only PAI bits;

FIG. 5 is a diagram of a preamble including a PCR segment for the current preamble and a PAI segment;

FIG. 6 is a diagram of a preamble including a PAI segment and a PCR segment for the next preamble;

FIG. 7 is a diagram of a preamble including a PCR segment for the current preamble, a PAI segment, and a PCR segment for the next preamble;

FIG. 8 is a flowchart of a method for processing a preamble at a Node B; and

FIG. 9 is a block diagram of a receiver including a detector for a preamble including PCR and PAI bits.

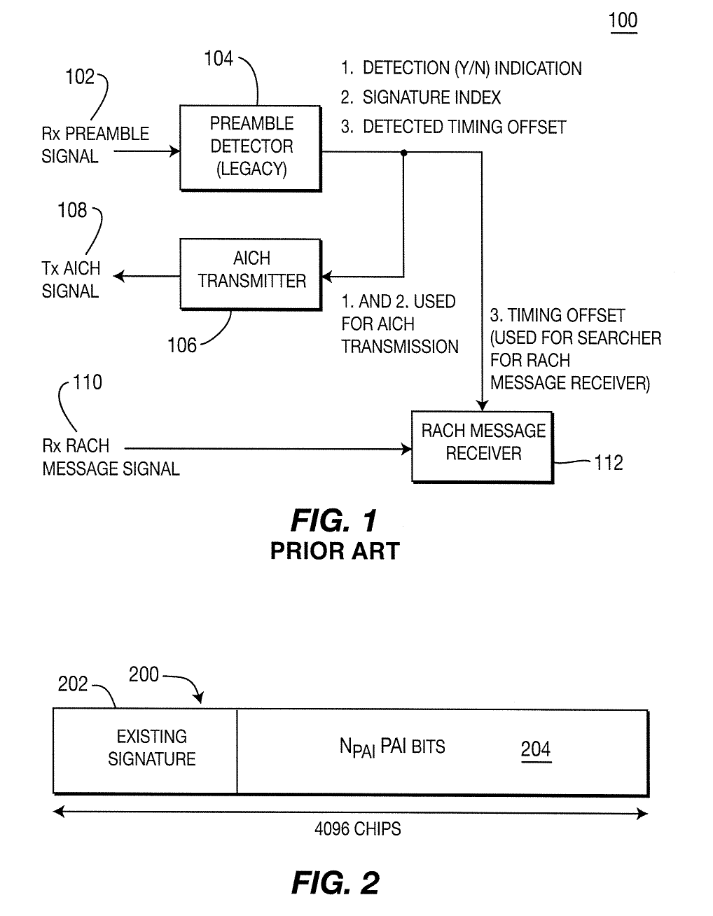

### DETAILED DESCRIPTION OF THE PREFERRED EMBODIMENTS

When referred to hereafter, the term “wireless transmit/receive unit (WTRU)” includes, but is not limited to, a user equipment (UE), a mobile station, a fixed or mobile subscriber unit, a pager, a cellular telephone, a personal digital assistant (PDA), a computer, or any other type of user device capable of operating in a wireless environment. When referred to hereafter, the term “base station” includes, but is not limited to, a Node B, a site controller, an access point (AP), or any other type of interfacing device capable of operating in a wireless environment.

The present invention may be especially relevant given the trend in 3GPP long term evolution (LTE) (Release 7 and above) standardization efforts to move much of the radio link control (RLC) functionalities from the network to the Node B.

In accordance with the present invention, PRACH access information (PAI) and/or preamble channel resources (PCR) are carried by the PRACH preamble. The PAI includes information about the user or the access that the user desires, and the PCR indicates channel resources for the PRACH preamble.

The PAI and PCR can replace the signature in the preamble, but in a flexible manner. Alternatively, the PAI and PCR can complement the transmission of existing signatures. For example, if the PAI can be chosen to be carried in signals transmitted in select access slots (but not all access slots) and the preambles that are transmitted in the rest of the access slots, the existing signatures can be used. There are also cases where some of the PCRs, such as the time-segment (within the 4096 chip-long signal), can be used to carry the existing signature and the rest the PAIs. For example, as shown in FIG. 2, a preamble 200 can use the existing signature in a first 1024 chip-long section 202 and then carry the PAI bits in the remaining 3072 chip-long segment 204.

As for the overall length of the preamble, it is not recommended to extend it over the current length limit of 4096 chips. However, the preamble length can be flexibly reducible below 4096 chips, and such allocation flexibility can be either implicitly pre-agreed or can be indicated by using explicit PCR bits in the preamble.

The PAI can include, but is not limited to:

(1) One or more Access Priority Indication (API) bit(s). A preferred embodiment uses one API bit; additional bits can be used to indicate a finer granularity of quality of service.

(2) Desired UL Traffic Channel Attribute Indication (UTCAI) bit(s). In a preferred embodiment, a two bit transport format combination indicator (TFCI) of the desired uplink channel can be included in the UTCAI. A larger UTCAI (e.g., 256 bits) can be used to indicate (with repetition or coding) the two bit TFCI information.

(3) PRACH Message-Part Attribute Indication (PRMAI) bit(s). In a preferred embodiment, one bit is used to indicate a “(desired) response priority” for the RACH message. This field does not need to be limited to one bit.

(4) Other message-part attribute possibilities include an indication of upcoming use of a variable length of RACH message part (currently not supported in the standard), etc.

The additional information provided by the PAI adds flexibility and versatility to the access indication-only nature of the prior art PRACH preamble. The four bit length of the PAI is exemplary, and the PAI length can be flexible. Theoretically, by using a very low processing gain of one (i.e., one bit per chip), the PAI could carry up to 4096 bits in a segment, although this would be possible only in a most favorable case with respect to RF propagation loss.

Examples of the PCR information include, but are not limited to: the length of the preamble (up to the maximum 4096 chips), the number of PAI bits (i.e., N_{PAI}) carried in the preamble, the start position (in chips) of the PAI segment, the transmission power level of the PAI segment (relative to the PCR segment), the interleaving pattern or coding used to carry the PAI bits on the preamble, and the composition of the PAI segment (i.e., number, type, order, and composition of the PAI bits carried, etc.).

The PCR may indicate different subsets of sub-carriers (in the case of orthogonal frequency division multiplexing (OFDM) or orthogonal frequency division multiple access (OFDMA)), different time lengths for the preamble transmission (e.g., a factor of two division or multiplication of the existing 4096 chip RACH preamble length), different subsets of signatures to be used in detection of the preamble, and different subsets of access slots to be used in detection of the preamble.

The PCR information bit length is also flexible. The PCR information can be carried on the preamble explicitly, or can be understood and used on the transmitter and the receiver to determine the composition (length, power, access slot selection, signature selection, etc.) of the preamble signal, or a combination of both. Different PCRs may be allocated for different users based on geographical (or radio propagation channel) location or access priority requirements, etc.

The PAI bits are inserted into the preamble by re-using the current signature fields as much as possible. The flexibility is increased by allowing different combinations of the API bits, UTCAI bits, and PRMAI bits. For example, the PAI bits may carry API bits only, for a simple extension to add access priority; may carry API bits and PRMAI bits, to add supporting information for the PRACH message; or may carry API bits and UTCAI bits, to add desired attributes of the UL traffic channel. These example options are summarized in Table 1.

TABLE 1

| Option | API | PRMAI | UTCAI |
|---|---|---|---|
| 1 | 1 bit (b0) | — | — |
| 2 | 1 bit (b0) | 1 bit (b1) | — |
| 3 | 1 bit (b0) | 1 bit (b1) | 2 bits (b2, b3) |

Alternatively, different time segments may be assigned for the API bits, (e.g., b0, b1, b2, and b3). For example, different signature subsets may be assigned to each of the PAI bits as follows:
Cₚₐᵢ(k)=C_{sig,s}(k)×b0,k=0, 1, . . . , 1023 Equation (2a)
C_{sig,s}(k)×b1,k=1024, . . . , 2047 Equation (2b)
C_{sig,s}(k)×b2,k=2048, . . . , 3071 Equation (2c)
C_{sig,s}(k)×b3,k=3072, . . . , 4095 Equation (2d)

Another approach is to use a higher-order Hadamard sequence for the PAI bits. The existing preamble uses Hadamard sequences with length 16, i.e., C_{sig,s}(k) in Equation (1), in a repeating pattern. In this approach, Hadamard sequences with lengths longer than 16 and up to 4096 can be used to carry the PAI information. In this case, the preamble is generated by the formula:

$${C}_{pai} ( k ) = {S}_{r \text{-} pre , n} ( k ) \times {C}_{HDM \text{-} N} ( k ) \times {ⅇ}^{j ( \frac{π}{2} + \frac{π}{2} k )} , \\ k = 0 , 1 , … , 4095 \qquad Equation ( 3 )$$

where C_{HDM-N}(k) is a repetition of one of the N Hadamard sequences of length N, where N could be 32, 64, 128, 256, 512, 1024, 2048, or 4096. It is noted that up to log(N)/log(2) PAI information bits, i.e., five to 12 such bits (for N=32, 64, . . . , or 4096), are carried on the Cₚₐᵢ(k) signal of Equation (3). This approach has an advantage of allowing the preamble detector to use a length-N Fast Hadamard Transform (FHT) block as well as a code matched filter (CMF) matched to the long scrambling code S_{r-pre,n}(k). Both the CMF and the length-N FHT block (with some modifications) are re-useable from existing preamble detectors for the existing PRACH preamble, since the existing detectors use the same CMF and a length-16 FHT block.

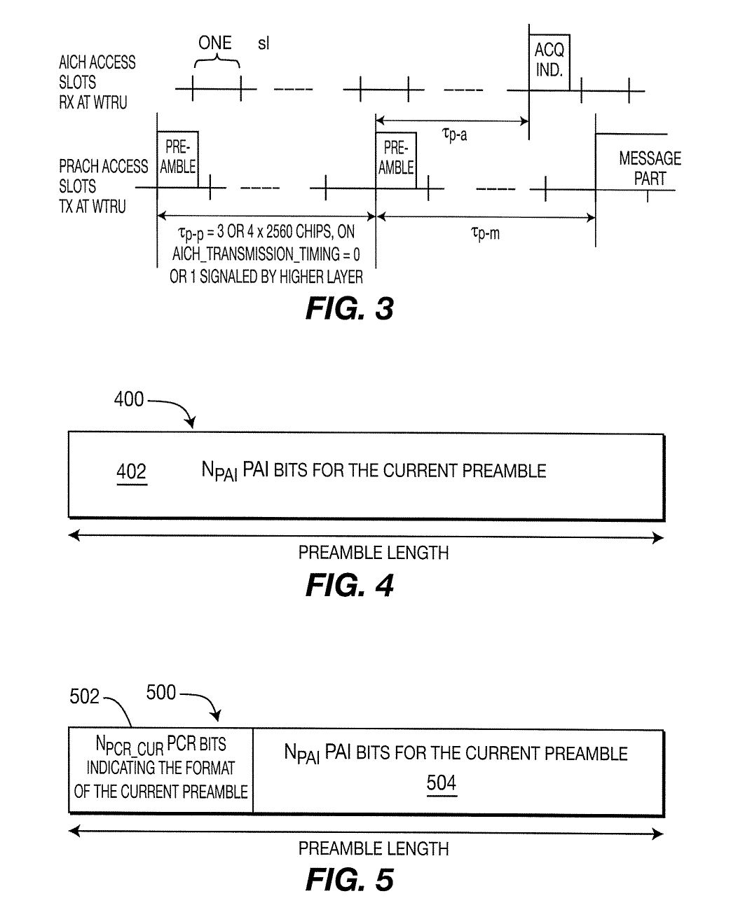

Yet another approach is to use different access slots and/or different signatures to carry the different PAI bits. FIG. 3 shows the timing relationship between multiple preambles and a corresponding acquisition indicator. For example, out of the possible 15 access slots and 16 signatures that can be chosen within any 20 ms of time, the WTRU may use only a subset of the access slots and/or signatures to carry particular PAI bits, and this information can be decoded by the Node B by examining the detected signatures and access slots a particular WTRU chooses to use in its preamble.

Although the preamble alone (even with the addition of the PAI) cannot be used to identify the WTRU ID and prepare the Node B for ID-specific processing, the decoded PAI can be useful in preparing the Node B resources for an unspecified WTRU.

The prior art PRACH preamble uses a single, fixed, high processing gain mapping of the user information (the four bit signature) to the 4096 bit long preamble physical signal. The prior art mapping scheme is designed to allow the worst case (i.e., cell-edge) user to be able to request uplink access reliably by providing a superfluous channel resource for uplink access. In the prior art, there is a mechanism to allow some flexibility by allowing power ramping up in successive preamble transmissions. However, transmit power is only one component of the channel resources. The other components, such as frequency band (all 5 MHz), time (4096 chips), and information repetition factor (256 repetitions of the 16 chip signature), are all fixed in the prior art PRACH preamble.

By allowing a more flexible allocation of all channel resources, i.e., transmit power, frequency (in the case of OFDM or OFDMA), time (segments), access slots, and repetition factor, different WTRUs can make access attempts with different functionalities and measures of performance. In the most general sense, the PCRs and the PAIs together can form a tiling pattern for the available entirety of the preamble-related channel resources.

Different cases of the PAI versus explicit PCR information carriage over the preamble can be considered. The explicit PCR bits are intended to indicate the composition of the preambles used in the current preamble (and/or that of the preamble to be transmitted in the next transmission) to the recipient. These cases are as follows.

FIG. 4 shows a preamble 400, which is Case 1. In the preamble 400, the composition and format of the PAI bits are already known in advance, so no explicit PCR bits are transmitted. The preamble 400 includes a PAI segment 402.

FIG. 5 shows a preamble 500, which is Case 2. The preamble 500 includes both a PCR segment 502 and a PAI segment 504. The PCR segment 504 indicates the format and composition of the preamble 500. In this example, the PCR segment 502 includes N_{PCR}_{_{—}}_{CUR} PCR bits to indicate the format of the preamble 500. The PAI segment 504 includes N_{PAI} bits.

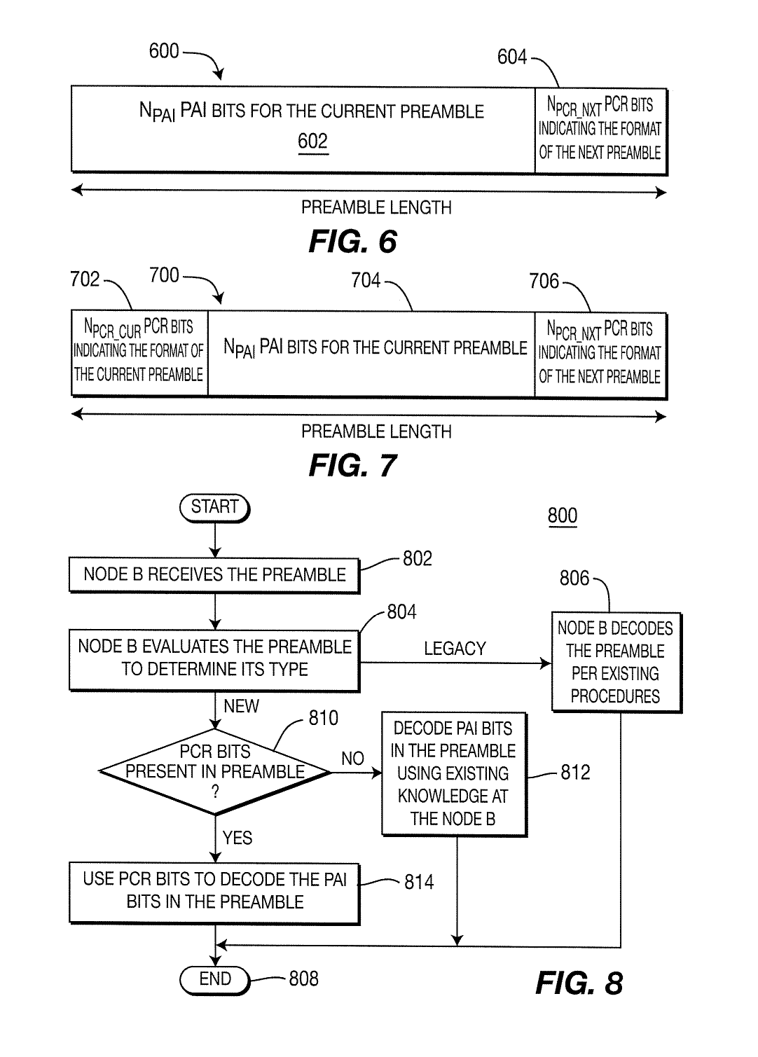

FIG. 6 shows a preamble 600, which is Case 3. The preamble 600 includes both a PAI segment 602 and a PCR segment 604. The PAI segment 602 indicates the PAI bits for the current preamble. The PCR segment 604 indicates the format and composition of the next preamble. The next-preamble PCR segment 604 could indicate, in addition the information listed above in Case 2, such PCR information as: particular access sub channel(s) (ASCs) that the next preamble transmission will or can take place, selected Access Slots (ASs) within the selected ASCs that the next preamble transmission will or can take place, and power levels of the next preamble transmission.

FIG. 7 shows a preamble 700, which is Case 4. The preamble 700 includes a PCR segment 702 for the current preamble, a PAI segment 704 for the current preamble, and a PCR segment 706 for the next preamble.

Schemes for informing the receiver if the PRACH preamble is a legacy type preamble or if it carries the PAI are described hereinafter. In one embodiment, if the PAI is to be carried on the PRACH preamble, the transmitter uses a time-advanced version of scrambling code as follows:

$${C}_{pre , n , s} ( k ) = {S}_{r \text{-} pre , n} ( k ) \times {C}_{pai} ( s , k ) \times {ⅇ}^{j ( \frac{π}{4} + \frac{π}{2} k )} , \\ k = 0 , 1 , … , 4095 \qquad Equation ( 4 )$$

where D is a delay parameter known in advance to both the transmitting side and the receiving side, and Cₚₐᵢ(s,k) is a new signal that carries the PAI. The Cₚₐᵢ(s,k) is designed for legacy-friendliness.

Alternatively, a phase-inverted version of the harmonizing factor may be used as follows:

$${C}_{pre , n , s} ( k ) = {S}_{r \text{-} pre , n} ( k ) \times {C}_{pai} ( s , k ) \times {ⅇ}^{j ( \frac{π}{4} - \frac{π}{2} k )} , \\ k = 0 , 1 , … , 4095 \qquad Equation ( 5 )$$

At the Node B, the new PAI indication is decoded by parallel decoding with a delayed scrambling code, or parallel decoding with an inverse-rotated phasor. The legacy PRACH-preamble receiver blocks such as the Fast Hadamard Transform (FHT) blocks may be reused.

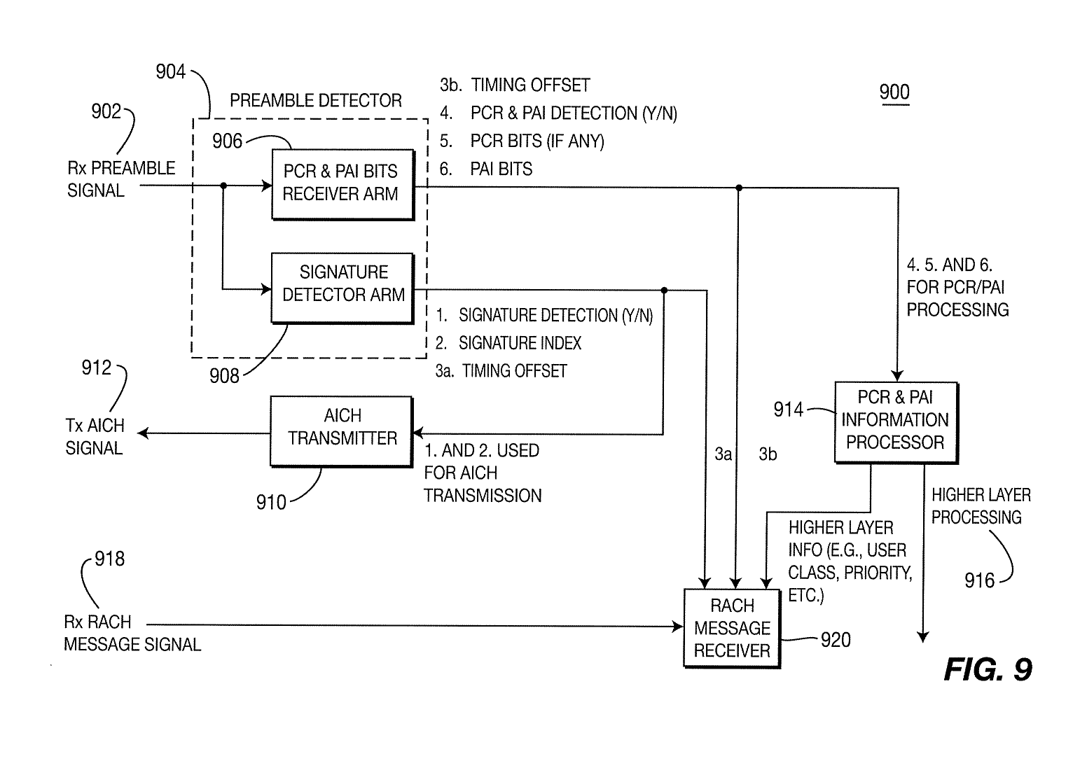

In order for the Node B to receive the PAI, the Node B needs to have a receiver that can receive both the existing RACH preamble and the new preamble, for legacy support reasons. The use of the time-advanced code or the phase-inverted transmission is intended to more easily construct such a receiver by using components that are already developed (such as the scrambling code generator and multiplier) for the existing preamble. The new receiver would have an arm for the existing preamble and another arm for the new preamble. (See FIG. 9 and discussion thereof.) The receiver determines if it has received new the RACH preamble signal by inspecting the signal levels of the new preamble arm of the receiver. As for the Node B determining what the PAI bits are, it can use either a pre-arranged knowledge of the PCR/PAI or an explicit PCR bit transmitted in the preamble itself that indicates the format and composition of the PAI bits.

FIG. 8 is a flowchart of a method 800 for processing a preamble at a Node B. The method 800 begins with the Node B receiving the preamble (step 802). The Node B evaluates the preamble to determine its type, i.e., whether it is a legacy preamble or a new preamble (step 804). If the preamble is a legacy preamble, then the Node B decodes the preamble per existing preamble decoding procedures (step 806) and the method terminates (step 808). If the preamble is a new preamble, then the Node B examines the preamble to determine if there are any PCR bits present (step 810). If there are no PCR bits present in the preamble, then the Node B decodes the PAI bits using existing knowledge of the PAI bits (step 812) and the method terminates (step 808). If there are PCR bits present in the preamble (step 810), then the Node B uses the PCR bits to decode the PAI bits in the preamble (step 814) and the method terminates (step 808).

FIG. 9 is a block diagram of a receiver 900 including a detector for a preamble including PCR and PAI bits. A preamble signal 902 is received by a preamble detector 904. The preamble detector 904 includes a PCR and PAI bit receiver arm 906 and a signature detector arm 908. The signature detector arm 908 outputs three signals: (1) a signature detection indication (a yes or no value), (2) a signature index, and (3) a first timing offset. The signature detection indication and the signature index are provided to an AICH transmitter 910 which outputs an AICH signal 912.

The PCR and PAI bit receiver arm 906 output four signals: (1) a second timing offset; (2) a PCR and PAI detection indication (a yes or no value); (3) the PCR bits, if present; and (4) the PAI bits. The PCR and PAI detection indication, the PCR bits, and the PAI bits are passed to a PCR and PAI information processor 914 which passes information on to higher layer processing 916.

A RACH message signal 918 is received by a RACH message receiver 920, which uses the first timing offset from the signature detector arm 908, the second timing offset from the PCR and PAI bit receiver arm 906, and higher layer information from the PCR and PAI information processor 914 to properly receive the message signal 918. In some implementations, only one of the two timing offsets—one from the signature detector 908 and the other from the PAI and PCR bit receiver 906—may be used in the RACH message receiver 920.

The present invention can be extended to the downlink acquisition indication channel (AICH), which uses similar approaches as for the PRACH preamble. The present invention is also applicable to high speed uplink packet access (HSUPA) channels using similar approaches and OFDM, OFDMA, or SC-FDMA uplink preambles by allocating PAI and PCR into not only time and signatures, but also to frequencies. A downlink channel (e.g., broadcast control channel (BCCH)) can be made to broadcast the available PCRs for uplink access, and the WTRUs can make use of such information in deciding the type and content of the information it will carry in its PRACH preambles.

The present invention may be implemented in any type of wireless communication system, as desired. By way of example, the present invention may be implemented in any type of WCDMA type system, UMTS-FDD, LTE OFDM, OFDMA, SC-FDMA, OFDM-MIMO, Enhanced Uplink, 3GPP LTE or any other type of wireless communication system. The present invention may also be implemented as a digital signal processor (DSP), software, hardware, or on an integrated circuit, such as an application specific integrated circuit (ASIC), multiple integrated circuits, logical programmable gate array (LPGA), multiple LPGAs, discrete components, or a combination of integrated circuit(s), LPGA(s), and discrete component(s).

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A preamble for use with an access channel in a wireless communication system, comprising:
at least one access information bit, each access information bit relating to information used in connection with an access grant request by a wireless transmit/receive unit (WTRU).

2. The preamble according to claim 1, wherein said at least one access information bit is selected from the group consisting of: access priority indication bits, uplink traffic channel attribute indication bits, and channel message part attribute indication bits.

3. The preamble according to claim 1, wherein the preamble includes four access information bits, including one access priority indication bit, two uplink traffic channel attribute indication bits, and one channel message part attribute indication bit.

4. The preamble according to claim 1, further comprising:
at least one preamble channel resource bit, said preamble channel resource bit indicating a format of the preamble.

5. The preamble according to claim 4, wherein said at least one preamble channel resource bit indicates the format of a current preamble.

6. The preamble according to claim 4, wherein said at least one preamble channel resource bit indicates the format of a next preamble.

7. The preamble according to claim 4 further comprising at least one second preamble channel resource bit, wherein said at least one preamble channel resource bit indicates the format of a current preamble, and wherein said at least one second preamble channel resource bit indicates the format of a next preamble.

8. The preamble according to claim 4, wherein said at least one preamble channel resource bit is selected from the group consisting of: a length of the preamble, a number of access information bits carried in the preamble, a start position of an access information segment in the preamble, a transmission power level of an access information segment in the preamble, an interleaving pattern of an access information segment in the preamble, and a coding used to carry an access information segment in the preamble.

9. The preamble according to claim 1, wherein the preamble is transmitted from the WTRU to a Node B using a time-advanced version of a scrambling code.

10. The preamble according to claim 9, wherein the time-advanced scrambling code is generated by the formula:
$${C}_{pre , n , s} ( k ) = {S}_{r \text{-} pre , n} ( k + D ) \times {C}_{pai} ( s , k ) \times {ⅇ}^{j ( \frac{π}{4} + \frac{π}{2} k )} ,$$
for k=0, 1, . . . , 4095, where D is a delay parameter known in advance to the WTRU and the Node B, and Cₚₐᵢ(s,k) is a signal carrying said at least one access information bit.

11. The preamble according to claim 1, wherein the preamble is transmitted from the WTRU to a Node B using a phase-inverted version of a harmonizing factor.

12. The preamble according to claim 11, wherein the phase-inverted version of the harmonizing factor is generated by the formula:
$${C}_{pre , n , s} ( k ) = {S}_{r \text{-} pre , n} ( k ) \times {C}_{pai} ( s , k ) \times {ⅇ}^{j ( \frac{π}{4} - \frac{π}{2} k )} ,$$
for k=0, 1, . . . , 4095.

13. The preamble according to claim 1, wherein said at least one access bit is inserted into the preamble by using a higher-order Hadamard sequence.

14. The preamble according to claim 13, wherein the Hadamard sequence has a length in a range from 32 bits to 4096 bits.

15. The preamble according to claim 13, wherein the preamble is generated by the formula:
$${C}_{pai} ( k ) = {S}_{r - pre , n} ( k ) \times {C}_{HDM - N} ( k ) \times {ⅇ}^{j ( \frac{π}{2} + \frac{π}{2} k )} , \\ k = 0 , 1 , … , 4095$$
where C_{HDM-N}(k) is a repetition of one of N Hadamard sequences of length N, where N is in a range from 32 to 4096.

16. A method for processing a preamble at a Node B, comprising the steps of:
receiving the preamble from a wireless transmit/receive unit;
evaluating the preamble to determine whether the preamble includes additional signaling bits; and
decoding the preamble based on whether the preamble includes additional signaling bits.

17. The method according to claim 16, wherein if the preamble does not include access information bits, then processing the preamble based on an existing procedure.

18. The method according to claim 16, wherein if the preamble includes access information bits, then determining whether the preamble includes channel resource bits and using the channel resource bits to decode the access information bits.

19. The method according to claim 18, wherein if the preamble does not include channel resource bits, then decoding the access information bits using existing knowledge at the Node B.

20. A receiver, comprising:
a preamble detector for processing a received preamble;
an access indicator channel (AICH) transmitter communicating with said preamble detector, said AICH transmitter for transmitting an AICH signal using information from said preamble detector;
a preamble channel resource (PCR) and physical random access channel (PRACH) access information (PAI) information processor communicating with said preamble detector; and
a random access channel (RACH) receiver communicating with said preamble detector and said information processor, said RACH receiver for receiving a RACH message signal using information from said preamble detector and said information processor.

21. The receiver according to claim 20, wherein said preamble detector includes:
a PCR and PAI bit receiver arm communicating with said RACH message receiver and said information processor; and
a signature detector arm communicating with said AICH transmitter and said RACH message receiver.

22. The receiver according to claim 21, wherein said PCR and PAI bit receiver arm is configured to receive the preamble and to output a first timing offset, a PCR and PAI detection indicator, PCR bits, and PAI bits.

23. The receiver according to claim 22, wherein said PCR and PAI bit receiver arm outputs the first timing offset to said RACH message receiver.

24. The receiver according to claim 22, wherein said PCR and PAI bit receiver arm outputs the PCR and PAI detection indicator, the PCR bits, and the PAI bits to said information processor.

25. The receiver according to claim 21, wherein said signature detector arm is configured to receive the preamble and to output a signature detection indicator, a signature index, and a second timing offset.

26. The receiver according to claim 25, wherein said signature detector arm outputs the signature detection indicator and the signature index to said AICH transmitter.

27. The receiver according to claim 25, wherein said signature detector arm outputs the second timing offset to said RACH message receiver.

28. The receiver according to claim 20, wherein the received preamble uses a higher-order Hadamard sequence and said preamble detector includes:
a Fast Hadamard (FHT) block; and
a code matched filter (CMF).

29. The receiver according to claim 28, wherein said FHT block is a length-N FHT block, where N is a length of the Hadamard sequence used in the preamble.

30. The receiver according to claim 28, wherein said CMF is matched to a scrambling code used to create the preamble.
